(19) United States
(12) Patent Application Publication
(10) Pub. No.: US 2012/0236408 A1
(43) Pub. Date: Sep. 20, 2012

(54) OUTSTANDINGLY DURABLE AND HEAT-RESISTANT POLARISING ELEMENT, POLARISING PLATE AND IMAGE-DISPLAY DEVICE, AND POLARISING-ELEMENT PRODUCTION METHOD

(76) Inventors: Ki-Ok Kwon, Seo-gu (KR); Seung-Ae Kim, Yuseong-gu (KR); Kyun-II Rah, Seo-gu (KR)

(21) Appl. No.: 13/147,112

(22) PCT Filed: Jan. 29, 2010
(86) PCT No.: PCT/KR10/00570

§ 371 Date: Jul. 29, 2011

(30) Foreign Application Priority Data
Jan. 30, 2009 (KR) 10-2009-007632

(51) Int. Cl. G02B 5/30; B08B 3/00; G02B 1/08

(52) U.S. Cl. 359/483.01; 252/585; 134/26

(57) ABSTRACT

The present invention relates to a polarizer in which contents of zinc, boron, and potassium are controlled to be within a certain range, a polarizing plate, and an image display device having excellent durability and heat resistance, and a method of manufacturing the polarizer. In one embodiment, the present invention provides a polarizer, in which the value of zinc content (wt. %)×boron content (wt. %)/potassium content (wt. %) is 0.1 to 4.0, boron content is 1.0 wt. % to 5.0 wt. % and potassium content is 0.3 wt. % to 2.0 wt. %, based on the weight of the polarizer, a polarizing plate and an image display device including the same. Further, the present invention provides a method of manufacturing a polarizer, the method including at least a dyeing process, a cross-linking process, a stretching process and a washing process.

### TECHNICAL FIELD

The present invention relates to a polarizer, a polarizing plate, and an image display device having excellent durability and heat resistance, and a method of manufacturing the polarizer, and more particularly, to a polarizer in which contents of zinc, boron, and potassium are controlled to be within a certain range, a polarizing plate, and an image display device having excellent durability and heat resistance, and a method of manufacturing the polarizer.

### BACKGROUND ART

A polarizing plate used in an image display device, such as a liquid crystal display (LCD), an organic electroluminescence (EL) display device, a plasma display panel (PDP) or the like, is required to have high transmittance and a high degree of polarization so as to provide an image exhibiting excellent color reproducibility. This polarizing plate according to the related art is manufactured by dyeing a polyvinyl alcohol film through the use of dichroic iodine, dichroic dyes, or the like, cross-linking the dyed film and then orienting the cross-linked film through a method such as uniaxial stretching or the like.

Recently, an image display device using a polarizing plate has been used in a television (TV), a monitor, an instrument panel for an automobile, a computer, a laptop computer, a personal data assistant (PDA), a telephone, an audio/video apparatus, and a display plate for various office and industrial equipment. In this manner, as the fields of use of an image display device have been expanded, the long-term use of a polarizing plate has increased under harsh conditions, such as high temperature, high humidity or the like. Accordingly, a polarizing plate having excellent durability and heat-resistance may be required so as to perform the original functions thereof under the harsh conditions.

The durability of the polarizing plate according to the related art has been improved through a method of modifying a polyvinyl alcohol film itself and/or using non-sublimable dichroic dyes instead of an iodine-type polarizer having sublimable properties. However, in the method of modifying a polyvinyl alcohol based (hereinafter, referred to as ‘PVA’) film itself, according to the related art, defects may occur, such as a degradation in the degree of polarization due to insufficient adsorption of iodine or dichroic dyes by a polymer matrix, and a deterioration in transmittance due to the modification of the polymer matrix. In the method of using the non-sublimable dichroic dyes, the control of orientation is difficult at the time of stretching a PVA film, whereby a sufficient degree of polarization may not be obtained.

### DISCLOSURE

### Technical Problem

An aspect of the present invention provides a polarizer exhibiting excellent durability and heat resistance.

An aspect of the present invention also provides a polarizing plate and image display device including the polarizer exhibiting excellent durability and heat resistance.

An aspect of the present invention also provides a method of manufacturing the polarizer exhibiting excellent durability and heat resistance.

### Technical Solution

According to an aspect of the present invention, there is provided a polarizer having a value of zinc content (percent by weight, wt. %)×boron content (wt. %)/potassium content (wt. %) in a range of 0.1 to 4.0, boron content in a range of 1.0 to 5.0 wt. % and potassium content in a range of 0.3 to 2.0 wt. %, based on a weight of the polarizer.

According to another aspect of the present invention, there is provided a polarizing plate including the polarizer according to an aspect of the present invention.

According to another aspect of the invention, the invention provides an image display device including the polarizer or a polarizing plate according to an aspect of the present invention.

According to another aspect of the present invention, there is provided a method of manufacturing a polarizer comprising at least a dyeing process, a cross-linking process, a stretching process, and a washing process, the dyeing process being performed by immersing a PVA film in an aqueous dyeing solution having an iodine concentration in a range of 0.05 wt. % to 0.2 wt. % (percent by weight), a potassium iodide concentration in a range of 0.2 wt. % to 1.5 wt. %, and a temperature in a range of 20° C. to 40° C. (degrees Celsius) for 150 seconds to 300 seconds; the cross-linking process being performed by immersing the PVA film in an aqueous cross-linking solution having a boron concentration in a range of 0.36 to 0.83 wt. %, a potassium iodide concentration in a range of 4 to 7 wt. %, and a temperature in a range of 15 to 60° C. (degrees Celsius) for 30 to 120 seconds; at least one kind of zinc salt selected from a group consisting of zinc chloride, zinc iodide, zinc sulfate, zinc nitrate, and zinc acetate being included in at least one of the aqueous dyeing solution, the aqueous cross-linking solution, and a separate aqueous zinc salt processing solution in a concentration of 0.4 to 7.0 wt. %; and the washing process being performed by immersing the PVA film in pure water having a temperature of 25 to 30° C. (degrees Celsius) for 10 to 30 seconds.

### Advantageous Effects

A value of zinc content (wt %)×boron content (wt %)/potassium content (wt %) is controlled to be within a range of 0.1 to 4.0, boron content is controlled to be within a range of 1.0 to 5.0 wt %, and potassium content is controlled to be within a range of 0.3 to 2.0 wt %, such that the polarizer, the polarizing plate and the image display device including the polarizer show excellent initial cross transmittance and color characteristics, maintain such properties, and have excellent durability and heat resistance by which initially excellent transmittance, degree of polarization, and color are maintained even in the case they are left standing under high temperature conditions.

### DESCRIPTION OF DRAWINGS

FIG. 1 is a graph illustrating (Zn+P)*B values versus polarizer thicknesses according to Comparative Example 1 and Inventive Examples 1, 9 and 10 of the present invention.

### BEST MODE

The inventors of the present invention discovered, from the results of research into polarizer and polarizing plates having excellent durability and heat resistance, that a specific content relationship of zinc, boron, and potassium in the polarizer is highly correlated with durability and heat resistance, and the durability and heat resistance of the polarizer are significantly increased by controlling the specific content relationship of zinc, boron, and potassium, instead of a zinc content itself in the polarizer to thereby improve the durability and heat resistance of the polarizer.

Boric acid, borate, or borax used as a cross-linking agent in the preparation of the polarizer generates a hydroxyl group (OH) in an aqueous solution, and a polyvinyl alcohol based (hereinafter, referred to as the ‘PVA’) resin is cross-linked thereby. Also, polyiodies, in which iodine exists as I₅⁻ and I₃⁻, is inserted between cross-linked network structures by means of polyvinyl alcohol and a boron-supplying material. Therefore, it is considered that heat resistance is increased, because the higher the content of the boron-supplying material as a cross-linking agent is, the stronger the network structure between polyvinyl alcohol and polyiodies will be, and the more deformation of PVA and polyiodies and deterioration and/or sublimation of polyiodies will be prevented after stretching. However, heat resistant properties will not be infinitely improved even if boron (B) content is infinitely high, and a side effect of deteriorating initial cross optical properties (initial cross optical properties represents or is understood as degree of polarization) is generated when boron is used excessively. Also, heat resistance, as well as initial cross optical properties, deteriorates when the boron content is excessively low. Therefore, the present invention is characterized by controlling the boron content in a specific range in consideration of these factors.

Moreover, potassium (K) contained in the polarizer originates from KI (added to provide a neutral gray color). In a case in which potassium (K) content is extremely low, properties of the polarizer, such as an initial color, a degree of polarization and the like are deteriorated, whereby the use of the polarizer having the extremely low potassium (K) content in an image display device may be impossible. In addition, even in a case in which a great quantity of potassium (K) is contained in the polarizer, the properties of the polarizer, such as the initial color, the degree of polarization, and the like are deteriorated and heat resistance is also deteriorated. Therefore, an embodiment of the present invention is characterized by controlling potassium (K) content contained in the polarizer to be within a specific range.

In addition, durability and heat resistance of the polarizer are improved by adding zinc thereto. However, in a case in which zinc is added to the polarizer in an excessive amount, the initial optical properties of the polarizer may be deteriorated. Thus, zinc content contained in the polarizer needs to be controlled to an appropriate amount, in terms of controlling the initial optical properties, durability, and heat resistance of the polarizer.

In this manner, respective contents of zinc, boron and potassium contained in the polarizer relate to the initial optical properties of the polarizer, and the heat resistance and durability thereof under high temperature conditions. Thus, by controlling the contents of these constituents contained in the polarizer in such a manner as to satisfy a specific relational expression of the constituents, the polarizer may show excellent initial optical properties, such as the initial color, the degree of polarization or the like, and may exhibit superior durability and heat resistance in which changes in the excellent initial optical properties are minimized even in the case of being left under high temperature conditions.

According to an embodiment of the present invention, based on the result of research as described above, there is provide a polarizer, in which the value of zinc content (percent by weight, wt. %)×boron content (wt. %)/potassium content (wt. %) (Hereinafter, referred to as ‘Zn*B/K’) is 0.1 to 4.0, boron content is 1.0 to 5.0 wt. % and potassium content is 0.3 to 2.0 wt. %, based on the weight of the polarizer.

The polarizer is generally fabricated with a polyvinyl alcohol-based film, and a film formed of a polyvinyl alcohol resin or a derivative thereof may be used. Any polyvinyl alcohol-based derivative may be used as long as it is generally known in the art. Examples of the polyvinyl alcohol derivative may be modified polyvinyl alcohol copolymerized with a carboxylic acid or a derivative thereof, unsaturated sulfonic acid or a derivative thereof, or olefin such as ethylene or propylene, etc. However, the derivatives of polyvinyl alcohol are not limited thereto.

In the polarizer according to an embodiment of the present invention, the contents of constitutions thereof are controlled such that the value of Zn*B/K is 0.1 to 4.0, boron content is 1.0 to 5.0 wt. % and potassium content is 0.3 to 2.0 wt. %, based on the weight of the polarizer. That is, the specific relationship between the contents of zinc, boron and potassium contained in the polarizer is very closely correlated with the initial optical characteristics, durability, and heat resistance of the polarizer, and the value of Zn*B/K in the polarizer may be in the range of 0.1 to 4.0 based on the weight of the polarizer.

When the value of Zn*B/K in the polarizer is less than 0.1, an improvement in heat resistance of the polarizer is insignificant. When the value of Zn*B/K in the polarizer is more than 4.0, the initial color and degree of polarization thereof may not be maintained. As the value of Zn*B/K becomes greater but remains within the range of 0.1 to 4, the polarizer has superior durability and heat resistance, in which changes in transmittance, degree of polarization, and color characteristics are reduced under high temperature conditions.

In addition, in order to maintain the initial degree of polarization and color of the polarizer, the contents of constitutions thereof are controlled such that boron content is 1.0 to 5.0 wt. %, preferably, 2.0 to 5.0 wt. and potassium content is 0.3 to 2.0 wt. %, preferably, 0.3 to 1.0 wt. %, based on the total weight of the polarizer. The polarizing plate including the polarizer in which boron content is within the above range may exhibit an excellent initial cross color and degree of polarization. That is, when boron content is less than 1.0 wt. %, the initial cross optical properties and heat resistance may be degraded. When boron content is more than 5.0 wt. %, the initial cross optical properties may be degraded. In the case of potassium content being in the range of 0.3 wt. % to 2.0 wt. %, the polarizing plate may exhibit superior and stable initial color characteristics, degree of polarization, and heat resistance. In the case of the potassium content being less than 0.3 wt. % or more than 2.0 wt. %, the polarizing plate may exhibit degraded initial color characteristics, degree of polarization, and heat resistance.

The value of Zn*B/K, and the contents of zinc, boron, and potassium contained in the polarizer are measured by Inductively Coupled Plasma (ICP) method. That is, the contents may be measured by Inductively Coupled Plasma-Atomic Emission Spectrometry using an Inductively Coupled Plasma-Atomic Emission Spectrometer (ICP-AES).

Further, another embodiment of the present invention provides a polarizer, in which the value of [zinc content (wt. %)+phosphorus content (wt. %)]×boron content (wt. %) (Hereinafter, referred to as ‘[Zn+P]*B’) is 0.2 to 14.0, more preferably, 1.5 to 14.0 in respective locations, at which a depth (D) ranging from the surface of the polarizer to the center thereof satisfies 1 nm (nanometer)≦D≦60 nm (nanometers) (the depth (D) is between 1 nanometer or more and 60 nanometers or less).

The polarizer, in which the value of [Zn+P]*B is 0.2 to 14.0 in respective locations, at which the depth (D) ranging from the surface of the polarizer to the center thereof satisfies 1 nm (nanometer)≦D≦60 nm (nanometers), as well as the value of Zn*B/K satisfies the above range, may have more improved durability and heat resistance. In the case of further including phosphorus (P) to the polarizer, the value of [Zn+P]*B may be 0.2 or more in terms of further improvements in durability and heat resistance and may be 14.0 or less in terms of superior initial optical properties and color.

The value of [Zn+P]*B in the respective locations, at which the depth (D) ranging from the surface of the polarizer to the center thereof satisfies 1 nm (nanometer)≦D≦60 nm (nanometers) may be a value measured by an Electron Spectroscopy for Chemical Analysis (ESCA) method. Using a photoelectron spectrometer (X-ray photoelectron spectroscopy (XPS) or ESCA, model name ESCALAB 250(Vg)), the value of [Zn+P]*B and the contents of zinc, phosphorus, and boron contained in the polarizer may be obtained by the ESCA method. Concretely, the value of [Zn+P]*B may be calculated based on weight; however, it may actually be a value calculated by measuring atomic percentages (at %) of zinc, phosphorus, and boron in respective locations of the polarizer and converting the measured atomic percentages of zinc, phosphorus, and boron into weights of the respective elements.

Meanwhile, the polarizer according to an embodiment of the present invention may be manufactured by the following method such that the value of Zn*B/K, the value of [Zn+P]*B (provided that the depth (D) of the polarizer satisfies 1 nm (nanometer)≦D≦60 nm (nanometers)), boron content, and potassium content satisfy the above mentioned ranges.

The polarizer may be generally manufactured by dyeing, cross-linking, stretching, washing and drying a non-stretched PVA film. In the meantime, the processes of dyeing, cross-linking, and stretching may be individually or simultaneously undertaken. Further, the sequence of the respective processes may be also varied and accordingly the sequence of reaction steps is not fixed.

The dyeing process is a process of dyeing a polyvinyl alcohol based resin film with iodine or a dye, in which the polyvinyl alcohol based resin film is dyed with dichroic iodine molecules or dye molecules.

The dichroic iodine molecules or dye molecules absorb light vibrating in the stretched direction of a polarizing plate and transmit light vibrating in a direction perpendicular to the stretched direction, thereby enabling polarized light having a specific vibration direction to be obtained.

In general, dyeing is performed by immersing a PVA film in an aqueous dyeing solution. In manufacturing of the polarizer according to an embodiment of the present invention, the dyeing process is performed by immersing the PVA film in an aqueous dyeing solution for 150 seconds to 300 seconds, in which an iodine concentration is 0.05 wt. % to 0.2 wt. %, a potassium iodide concentration is 0.2 wt. % to 1.5 wt. %, and a temperature is 20° C. to 40° C. (degrees Celsius), preferably 20° C. to 35° C. (degrees Celsius).

When the iodine concentration of the aqueous dyeing solution in the dyeing process is less than 0.05 wt. %, the transmittance of the polarizer may be excessively high. On the other hand, when the iodine concentration of the aqueous dyeing solution in the dyeing process is more than 0.2 wt. %, the transmittance of the polarizer may be excessively low. In addition, when the concentration of potassium iodide is less than 0.2 wt. %, the amount of potassium iodide used as a dissolution aid for iodine is insufficient, and iodine may not be appropriately dissolved in the aqueous dyeing solution. On the other hand, when the concentration of potassium iodide is more than 1.5 wt. %, potassium iodide has in itself limitations in solubility to water and as result of this, foreign substances may be generated. When the temperature of the aqueous dyeing solution is less than 20° C. (degrees Celsius), water solubility of iodine and potassium iodide may be degraded and a rate of dyeing a PVA film may be lowered. When the temperature of the aqueous dyeing solution is more than 40° C. (degrees Celsius), iodine may be sublimated due to the high temperature. Meanwhile, a PVA film may be sufficiently immersed in the aqueous dyeing solution for 150 seconds or more in such a manner that the PVA film is sufficiently dyed with the aqueous dyeing solution. Meanwhile, the PVA film may be immersed in the aqueous dyeing solution for 300 seconds or less, in terms of the transmittance of the polarizer.

In the cross-linking process, the dye or iodine molecules may be adsorbed to the polymer matrix of the PVA film through a boron-supplying material, such as boric acid, borate, borax, or the like. If the dye or iodine molecules may not be properly adsorbed to the polymer matrix of the PVA film, the degree of polarization may be deteriorated, such that the polarizing plate may do not perform the original function thereof.

In general, cross-linking is performed by using a dipping method of dipping a PVA film into an aqueous cross-linking solution, containing a boron-supplying material; however, it may be performed by spraying or applying the aqueous cross-linking solution to the PVA film.

In manufacturing the polarizer according to an embodiment of the present invention, the cross-linking process is performed by immersing a PVA film in an aqueous cross-linking solution, in which a boron concentration is 0.36 to 0.83 wt. %, a potassium iodide concentration is 4 to 7 wt. %, and a temperature is 15 to 60° C. (degrees Celsius), for 30 to 120 seconds.

In the aqueous cross-linking solution of the cross-linking process, when the boron concentration is less than 0.36 wt. %, the PVA film may not be sufficiently cross-linked and the initial optical properties and durability of the polarizer may be deteriorated. When the boron concentration is more than 0.83 wt. %, water solubility of boron may be degraded. For example, the boron-supplying material may be at least one selected from the group consisting of boric acid, borate, and borax. However, the boron-supplying material is not limited thereto.

In addition, in the cross-linking process, potassium iodide may be added to the aqueous cross-linking solution, such that the aqueous cross-linking solution may contain iodide ions. In the case of using the aqueous cross-linking solution containing iodide ions, a polarizer having less coloration, that is, a neutral gray polarizer providing an approximately constant absorbance to all wavelength areas of visible light may be obtained. In order to implement an appropriate neutral gray color of the polarizer, the potassium iodide concentration in the aqueous cross-linking solution may be 4 wt. % or more. Meanwhile, when the potassium iodide concentration is more than 7 wt. %, an excessive amount of I⁻ may be provided due to the potassium iodide, and the forward reaction of the following reaction equation 1 may be accelerated at high temperature due to the excessive amount of I⁻, such that the polarizer may have color changes and a degradation in the degree of polarization after being left under high temperature conditions.

I⁻+I₅⁻->I₂+I₃⁻+I⁻ [Reaction Equation 1]

When the temperature of the aqueous cross-linking solution is less than 15° C. (degrees Celsius), the boron component-supplying material may be not sufficiently dissolved in the aqueous cross-linking solution. On the other hand, when the temperature of the aqueous cross-linking solution is more than 60° C. (degrees Celsius), the elution reaction of the boron-supplying material from the PVA film may be greater than a reaction in which the boron component-supplying material inflows to the film to be crosslinked, due to high temperatures, whereby an appropriate cross-linking reaction may not be generated.

Meanwhile, when the time for which a PVA film or a dyed PVA film is immersed in the aqueous cross-linking solution is less than 30 seconds, the boron component-supplying material may not sufficiently permeate in a depth direction of the PVA film, whereby the film may not be properly cross-linked. When the time for which a PVA film or a dyed PVA film is immersed in the aqueous cross-linking solution is more than 120, seconds, the cross-linking reaction of the PVA film may be excessively undertaken due to the introduction of excessive the boron component-supplying material into the PVA film, such that the initial optical properties of the polarizer may be deteriorated.

The stretching process refers to uniaxially stretching a film such that high molecules of the film are oriented in a certain direction. By stretching the film, iodine molecules or dye molecules are arranged in parallel with each other in the stretched direction of the film, and the iodine molecules (I₂) or dye molecules exhibit dichroism, whereby the film may absorb light vibrating in the stretched direction and transmit light vibrating in a direction perpendicular to the stretched direction.

Stretching methods may include wet stretching methods and dry stretching methods. The dry stretching methods may be divided into an inter-roll stretching method, a heating roll stretching method, a compression stretching method, a tenter stretching method or the like. The wet stretching methods may be divided into a tenter stretching method, an inter-roll stretching method or the like.

The stretching methods are not particularly limited in an embodiment of the present invention, and any stretching method known in the related art may be used. In addition, both of the wet stretching methods and the dry stretching methods may be used, and a combination of the stretching methods may be used if necessary. Stretching may be performed at a stretching ratio of 4 to 6 times. When the stretching ratio is less than 4 times, the stretching of the PVA film may be insufficient. On the other hand, when the stretching ratio is more than 6 times, the PVA film may be broken or the orientation of molecules in the PVA film may be deviated due to excessive stretching of the PVA film. Consequently, the orientation of iodide ions may be deteriorated, such that the initial optical properties of the polarizer may be degraded.

The stretching process may be undertaken simultaneously with or separately from the dyeing process or the cross-linking process. Moreover, in the case of separately performing wet stretching, the temperature of a stretching bath may be 35° C. (degrees Celsius) to 60° C. (degrees Celsius), preferably, 40° C. (degrees Celsius) to 60° C. (degrees Celsius). The temperature of the stretching bath may be 35° C. (degrees Celsius) to 60° C. (degrees Celsius) in terms of the smooth stretching of the PVA film, stretching process efficiency, the fracture prevention of the film during the stretching process, or the like. When the stretching process is undertaken simultaneously with the dyeing process, the stretching process may be performed within the aqueous dyeing solution. When the stretching process is undertaken simultaneously with the cross-linking process, the stretching process may be performed within the aqueous cross-linking solution. Furthermore, when the stretching process is undertaken simultaneously with the dyeing process, the cross-linking process, a zinc salt processing process to be described later, or an optional phosphorus compound processing process to be described later, the temperature of the aqueous solution may be selected in a narrower temperature condition overlapping with the temperature of a process performed simultaneously.

For example, in the case that the cross-linking process and wet stretching process are simultaneously undertaken, cross-linking and stretching may be performed at the aqueous solution temperature of the stretching bath during the stretching process.

Meanwhile, when the stretching is performed together with other processes and there is a process particularly desired to be performed smoothly among various processes, conditions of the corresponding process may be followed. Stretching time is not particularly limited, and in a case in which stretching may be performed together with the dyeing process, the cross-linking process, a separate zinc salt processing process, or a separate phosphorus compound processing process, it may be performed within the time range of the dyeing process, the cross-linking process, the separate zinc salt processing process, or the separate phosphorus compound processing process. In the case of separately performing wet stretching, it is not particularly limited, but the stretching may be performed in the time range of 60 seconds to 120 seconds, in consideration of the orientation of the PVA based film, the optical properties of the polarizer, and process efficiency.

The washing process may be undertaken by immersing the dyed, cross-linked, and stretched PVA based film in pure water of 25° C. to 30° C., such as ion exchanged water, distilled water or the like, for 10 seconds to 30 seconds. When the temperature of pure water is less than 25° C. (degrees Celsius), the dissolution and the removal of foreign substances may be insignificant. When the temperature of pure water is more than 30° C. (degrees Celsius), the excessive elution of boron, potassium, zinc, phosphorus, or the like from the PVA film may occur. When the immersion time of the PVA film in pure water is less than 10 seconds, washing effects may be insignificant. When the immersion time of the PVA film in pure water is more than 30 seconds, the excessive elution of boron, potassium, zinc, phosphorus, or the like from the PVA film may occur.

The washing process is undertaken in order to remove foreign substances remaining on the surface of the PVA film (the polarizer), after the dyeing, cross-linking, and stretching processes. In the washing process, the foreign substances remaining on the surface of the PVA film (the polarizer) may be removed and boric acid, iodine, potassium iodide, zinc salt and phosphorus contained in the PVA film (the polarizer) may be eluted into a washing solution and partially removed from the PVA film (the polarizer) thereby. In the case that the immersion time of the polarizer in the washing solution is longer and the temperature of the washing solution is higher, the contents of boric acid, iodine, potassium iodide, zinc salt and phosphorus eluted from the polarizer increase, and consequently, residual contents within the final polarizer may be reduced. Thus, the washing process may be undertaken by immersing the PVA film in pure water having a temperature of 25 to 30° C. (degrees Celsius) for 10 seconds to 30 seconds in such a manner that the value of Zn*B/K is 0.1 to 4.0, the value of [Zn+P]×B (1 nm (nanometer)≦D≦60 nm (nanometers) is 0.2 to 14, boron content is 1.0 wt. % to 5.0 wt. % and potassium content is 0.3 wt. % to 2.0 wt. % in the polarizer. In a case in which the order of the washing process varies, since the controlling of material content within the polarizer may be changed, the washing process may be undertaken immediately before a drying of the film, after the dyeing, cross-linking, and stretching processes.

The polarizer according to an embodiment of the present invention may also contain a zinc ingredient, and a zinc salt may be added in at least one of the dyeing process, the cross-linking process, the stretching process, and the separate zinc salt processing process in such a manner that the value of Zn*B/K in the polarizer is 0.1 to 4.0. The zinc salt may be added in any process of the dyeing process, the cross-linking process, the wet stretching process, and the separate zinc salt processing process, and may also be added in multiple processes among the processes.

The zinc salt may be introduced into the aqueous solution previously prepared in each process (for example, the aqueous dyeing solution in the dyeing process, the aqueous cross-linking solution in the cross-linking process, or a wet stretching bath) or may be introduced during the manufacturing of the aqueous solution for each process. In addition, the zinc salt may be introduced together with iodine, potassium iodide, and/or a boron-supplying material.

In the aqueous solution, the zinc salt may be 0.4 wt. % to 7.0 wt. %, preferably, 0.5 wt. % to 5.0 wt. %, more preferably, 0.5 wt. % to 3.0 wt. %. When zinc salt content is less than 0.4 wt. %, improvements in durability of the polarizer may be insignificant. When zinc salt content is more than 7 wt. %, foreign substances may be formed on the surface of the polarizer due to limitations in the solubility of the zinc salt. In a case in which the zinc salt is introduced in two or more of the processes, the zinc salt may be introduced as a content of 0.4 wt. % to 7 wt. % in the respective processes.

In a case in which zinc salt processing is performed together with the dyeing, cross-linking, or wet stretching process, the zinc salt processing may be performed under the conditions of the dyeing, cross-linking, or wet stretching process (the temperature of the aqueous solution and immersion time).

Meanwhile, when the zinc salt is processed in a separate process, the separate zinc salt processing process may be performed in any process prior to the washing process; however, it may be most effective immediately before the washing process. In the case of performing the separate zinc salt processing process, in particular, in a case in which the zinc salt processing process is undertaken in a separate process immediately before the washing process, the zinc salt processing may be performed by immersing the PVA based film in an aqueous zinc salt solution of 15° C. (degrees Celsius) to 40° C. (degrees Celsius) for 20 seconds to 60 seconds, for example, in consideration of the solubility of zinc salt, the permeability of zinc salt into the polarizer, process efficiency, and the optical properties of the polarizer. However, the zinc salt processing is not limited thereto. As the zinc salt, zinc chloride, zinc iodide, zinc sulfate, zinc nitrate, zinc acetate or the like may be used alone or a mixture of two or more thereof.

The polarizer according to an embodiment of the present invention may optionally contain a phosphorus component, as needed. A phosphorus component may be contained in the polarizer such a manner that the value of [Zn+P]*B (provided that the depth (D) of the polarizer satisfies 1 nm (nanometer)≦D≦60 nm (nanometers)) is 0.2 to 14.0 by adding phosphorous compound into at least one of the dyeing process, the cross-linking process, the stretching process, and a separate phosphorus compound processing process. The phosphorus compound may be added in any process of the dyeing process, the cross-linking process, the stretching process, and the separate phosphorus compound processing process and may also be added in the multiple processes among the processes.

The phosphorus compound may be introduced into the aqueous solution previously prepared in each process (for example, the aqueous iodine solution in the dyeing process or the aqueous cross-linking solution in the cross-linking process) or may be introduced during the manufacturing of the aqueous solution for each process. In addition, the phosphorus compound may be introduced together with iodine, potassium iodide, and/or a boron-supplying material.

In the case of further adding a phosphorus compound into the solution, the phosphorus compound may be added in the range of 10 wt. % or less, preferably, 0.2 to 10 wt. % (percent by weight), more preferably, 0.5 to 3.0 wt. %. As the phosphorus compound is further added as needed, the lowest limit concentration thereof in the solution may not be particularly specified. However, phosphorus compound content may be at least 0.2 wt. % such that additional improvements in durability and heat resistance of the polarizer are sufficiently exhibited, and may be 10 wt. % or less in consideration of the water solubility of the phosphorus compound and the initial cross optical properties of the polarizer. Even in a case in which the phosphorus compound is introduced into at least two of the processes, the phosphorus compound may be introduced in the range of 10 wt. % or less in the aqueous solution of each process, similarly to the above concentration range of the phosphorus compound.

When the phosphorous compound processing process (i.e. addition of phosphorous compound in the solution) is performed together with the dyeing, cross-linking, or the wet stretching process by adding the phosphorus compound into the process, it may be undertaken in compliance with the conditions of the dyeing, cross-linking, or the wet stretching process (solution temperature and immersion time).

In addition, when the phosphorus compound processing process is processed in a separate process, the separate phosphorus compound processing process may be performed in any process prior to the washing process; however, it may be most effective immediately before the washing process. In the case of performing the separate phosphorus compound processing process, in particular, in a case in which phosphorus compound processing is undertaken in a separate process immediately before the washing process, the phosphorus compound processing may be performed by immersing the PVA based film in an aqueous phosphorus compound solution of 15° C. (degrees Celsius) to 40° C. (degrees Celsius) for 20 seconds to 60 seconds, for example, in consideration of the solubility of a phosphorus compound, the permeability of phosphorus compound into the polarizer, process efficiency, and the optical properties of the polarizer. However, the phosphorus compound processing is not limited thereto.

As the phosphorus compound, at least one selected from the group consisting of phosphoric acid, a calcium phosphate dibasic, a magnesium phosphate dibasic, a sodium phosphate dibasic, a calcium phosphate monobasic, and an ammonium phosphate monobasic may be used alone or in a combination thereof.

However, the zinc salt and the phosphorus compound may not be simultaneously added in the same process. That is, the zinc salt and the phosphorus compound may be individually added to the dyeing, cross-linking, or stretching process; however, they are not simultaneously added to the same process. For example, both of the zinc salt and the phosphorus compound may not be added to the aqueous dyeing solution in the dyeing process. This is because that the zinc salt and the phosphorus compound react with each other in the solution to generate zinc phosphate which is insoluble in water.

The contents of iodine, potassium iodide, boron-supplying material, zinc salt, and optional phosphorus compound, the temperatures of the aqueous dyeing and cross-linking solutions, the immersion times of the PVA film in the aqueous solutions, the washing temperature, the washing time, or the like may be controlled within the above ranges in at least one of the dyeing process, the cross-linking process, the stretching process, and the separate zinc salt processing process or the separate phosphorus compound processing process, in such a manner that the value of Zn*B/K is 0.1 to 4.0, boron content is 1.0 wt. % to 5.0 wt. %, and potassium content is 0.3 wt. % to 2.0 wt. %, as well as the value of [Zn+P]*B (provided that the depth (D) of the polarizer satisfies 1 nm (nanometer)≦D≦60 nm (nanometers)) is 0.2 to 14.0.

When the dyeing, cross-linking, stretching, and washing processes of the PVA film are completed, the PVA film is putted into an oven to be dried, such that a polarizer may be obtained. The drying process may be generally undertaken at a temperature of 40° C. to 100° C. (degrees Celsius) for 10 seconds to 500 seconds. When a dry temperature is less than 40° C. (degrees Celsius), the drying of moisture remaining in the PVA film may be insufficient, such that creases in the film may be generated. Further, the polarizer may be bluish, rather than exhibiting a neutral gray color, whereby the initial cross properties thereof may be deteriorated. In concrete, the ratio of the respective iodide ions may be properly adjusted through a reaction, such as that of the Reaction Equation 1, such that the polarizer may exhibit the neutral gray color. Meanwhile, this reaction may be more accelerated by heat supplied in the drying process of the PVA film, and the color of the polarizer may appear nearly bluish, prior to the color adjustment thereof based on the principles. Accordingly, when the temperature of drying process is lower, the reaction, such as the Reaction Equation 1, may not be smoothly performed and the color of the polarizer is bluish, whereby the initial cross properties may be deteriorated. When the dry temperature is more than 100° C. (degrees Celsius), the PVA film may be fragile due to the excessive drying thereof and the initial color of the polarizer may exhibit a red color, beyond the neutral gray color, such that the initial cross properties may be deteriorated. When drying time is less than 10 seconds, drying is insufficient. When drying time is more than 500 seconds, the PVA film may be fragile due to the excessive drying thereof and the initial color of the polarizer may exhibit a red color, beyond the neutral gray color, whereby that the initial cross properties may be deteriorated.

A polarizing plate is fabricated by stacking a protective film using an adhesive on one or both sides of the polarizer fabricated by the foregoing method. The protective film is for preventing outer sides of the polarizing plate from being exposed during the performing of processes and functions to prevent the inflow of contaminants and to protect the surface of the polarizing plate.

As the resin film material of the protection film, a film material which is easily manufactured as a film, has excellent adhesion with the PVA film (the polarizer), and is optically transparent, may be used. The resin film material may be a cellulose ester film, a polyester film (a polyethylene terephthalate film or polyethylene naphthalate film), a polycarbonate film, a polyarylate film, a polysulfone (including a polyether sulfone) film, a norbornene resin film, a polyolefin film (a polyethylene film or polypropylene film), cellophane, a cellulose diacetate film, a cellulose acetate butyrate film, a polyvinylidene chloride film, a polyvinyl alcohol film, an ethylene vinyl alcohol film, a polystyrene film, a, a cyclo olefin polymer film, a polymethyl pentene film, a polyether ketone film, a polyether ketone imide film, a polyamide-based film, a fluororesin film, an nylon film, a polymethyl methacrylate film, a polyacetate film, a polyacryate film material, or the like; however, it is not limited thereto.

In particular, the film material of the protection film may be a cellulose ester film such as a triacetyl cellulose film (a TAC film), a cellulose acetate propionate film or the like, a polycarbonate film (a PC film), a polystyrene film, a polyarylate film, a norbornene resin film, or a polysulfone film, in terms of transparency, mechanical properties, and absence of optical anisotropy thereof. A triacetyl cellulose film (a TAC film) and a polycarbonate film (a PC film) may be more preferably used due to the easy manufacturing thereof as a film and the superior processability thereof. In particular, the use of a TAC film may be the most preferable.

The protection film for the polarizing plate may be subjected to surface modification treatment in order to improve adhesive strength thereof to the PVA film to which the protection film adheres. The specific examples of surface modification treatment may include a corona discharge treatment, a glow discharge treatment, a flame treatment, an acid treatment, an alkali treatment, an ultraviolet irradiation treatment, and the like. In addition, an undercoat layer may be provided, as well as a surface modification. The surface modification treatment using an alkaline solution among the examples of surface modification treatment may enhance adhesive strength of the protection film to the PVA film by introducing a group of —OH into the hydrophobic protection film to modify the surface of the protective film to have hydrophilic properties.

As adhesives, water-based adhesives may be generally used. As the water-based adhesives, any water-based adhesives commonly used in the art may be used. The water-based adhesives may include, for example, isocyanate-based adhesives, polyvinyl alcohol-based adhesives, gelatin-based adhesives, vinyl-based latex adhesive, water-based polyurethane adhesive, water-based polyester adhesive, and the like; however, they are not limited thereto. Among them, polyvinyl-based alcohol adhesives may be preferably used as the water-based adhesives. The water-based adhesives may include a cross-linking agent. The adhesives may be commonly used as an aqueous solution. The concentration of the aqueous adhesive solution may not be particularly limited; however, the concentration of the adhesive aqueous solution may be generally 0.1 wt. % to 15 wt. %, preferably, 0.5 wt. % to 10 wt. %, more preferably 0.5 wt. % to 5.0 wt. %, in consideration of applicability or stability in preservation. Additionally, the adhesives may be further combined with a coupling agent, such as a silane coupling agent, a titanate coupling agent, or the like, various kinds of tackifier, an ultraviolet absorber, an antioxidant, and a stabilizer, such as a heat-resistant stabilizer, a hydrolysis stabilizer, or the like.

The polarizer or the polarizing plate having the protection film adhered to one surface or two surface of the polarizer as described above, may be used, for example, in a liquid crystal display, an organic light emitting (EL) display device, a plasma display panel (PDP) or the like.

### MODE FOR INVENTION

Hereinafter, the present invention will be explained in detail with reference to Inventive and Comparative Examples; however, the present invention is not limited to the Examples set forth herein.

### Comparative Example 1

A PVA film having a thickness of 75 μm (micrometers) was immersed and dyed in a dyeing bath containing an aqueous solution including iodine of 0.1 wt. % and potassium iodide of 1 wt. % at 30° C. (degrees Celsius) for 5 minutes (A. dyeing process). The dyed polyvinyl alcohol film was immersed in an aqueous cross-linking solution including potassium iodide of 5 wt. % and boron of 0.64 wt. % at 50° C. (degrees Celsius) for 120 seconds and was stretched at an stretching ratio of 5 times (B. cross-linking and stretching processes). A polyvinyl alcohol film (polarizer) obtained through the processes was put in an oven and dried at 80° C. (degrees Celsius) for 5 minutes. When the drying of the polyvinyl alcohol film (polarizer) was completed, a TAC film having a thickness of 75 μm (micrometers) was adhered to two surfaces of the polarizer by using polyvinyl alcohol adhesives and was dried at 80° C. (degrees Celsius) for 5 minutes, to thereby manufacture a polarizing plate.

### Comparative Example 2

With the exception that the concentration of boron was adjusted to 0.22 wt. % and zinc nitrate of 2.5 wt. % was added in the cross-linking and stretching processes (B), a polarizer and a polarizing plate were manufactured by processes the same as those of Comparative Example 1.

### Comparative Example 3

With the exception that the concentration of potassium iodide was adjusted to 1.5 wt. % and zinc nitrate of 2.5 wt. % was added in the cross-linking and stretching processes (B), a polarizer and a polarizing plate were manufactured by processes the same as those of Comparative Example 1.

### Comparative Example 4

With the exception that zinc nitrate of 2.5 wt. % was added in the cross-linking and stretching processes (B) and then a washing process (C) of immersing the polyvinyl alcohol film in distilled water at 25° C. (degrees Celsius) for 100 seconds was performed, a polarizer and a polarizing plate were manufactured by processes the same as those of Comparative Example 1.

### Comparative Example 5

With the exception that the concentrations of iodine and potassium iodide were adjusted to 0.03 wt. % and 7 wt. % respectively, in the dyeing process (A), the concentrations of boron and potassium iodide were adjusted to 0.92 wt. % and 10 wt. %, respectively, and zinc chloride of 0.16 wt. % was added in the cross-linking and stretching processes (B), and the PVA film was immersed in distilled water at 40° C. (degrees Celsius) for 60 seconds in the washing process (C), a polarizer and a polarizing plate were manufactured by processes the same as those of Comparative Example 1.

### Comparative Example 6

With the exception that the concentration of potassium iodide was adjusted to 0.01 wt. % and zinc chloride of 1.0 wt. % was added in the cross-linking and stretching processes (B), a polarizer and a polarizing plate were manufactured by processes the same as those of Comparative Example 1.

### Comparative Example 7

With the exception that the concentration of iodine was adjusted to 0.3 wt. % in the dyeing process (A), the concentration of boron was adjusted to 2.5 wt. % and zinc chloride of 2.5 wt. % was added in the cross-linking and stretching processes (B), and the polyvinyl alcohol film was immersed in distilled water at 25° C. (degrees Celsius) for 20 seconds in the washing process (C), a polarizer and a polarizing plate were manufactured by processes the same as those of Comparative Example 1.

### Inventive Example 1

With the exception that zinc nitrate of 2.5 wt. % was added in the cross-linking and stretching processes (B) and then the washing process (C) of immersing the polyvinyl alcohol film in distilled water of 25° C. (degrees Celsius) for 20 seconds was performed, a polarizer and a polarizing plate were manufactured by processes the same as those of Comparative Example 1.

### Inventive Example 2

With the exception that zinc nitrate of 5 wt. % was added in the cross-linking and stretching processes (B) and then the washing process (C) of immersing the polyvinyl alcohol film in distilled water of 25° C. (degrees Celsius) for 20 seconds was performed, a polarizer and a polarizing plate were manufactured by processes the same as those of Comparative Example 1.

### Inventive Example 3

With the exception that the concentration of potassium iodide was adjusted to 7.0 wt. % and zinc nitrate of 5 wt. % was added in the cross-linking and stretching processes (B), and then the washing process (C) of immersing the polyvinyl alcohol film in distilled water of 25° C. (degrees Celsius) for 20 seconds was performed, a polarizer and a polarizing plate were manufactured by processes the same as those of Comparative Example 1.

### Inventive Example 4

With the exception that the concentration of boron was adjusted to 0.46 wt. % and zinc sulfate of 2.5 wt. % was added in the cross-linking and stretching processes (B), and then the washing process (C) of immersing the polyvinyl alcohol film in distilled water of 25° C. (degrees Celsius) for 20 seconds was performed, a polarizer and a polarizing plate were manufactured by processes the same as those of Comparative Example 1.

### Inventive Example 5

With the exception that the concentrations of boron and potassium iodide were adjusted to 0.46 wt. % and 7 wt. % respectively, and zinc sulfate of 2.5 wt. % was added in the cross-linking and stretching processes (B), and then the washing process (C) of immersing the PVA film in pure water of 25° C. (degrees Celsius) for 20 seconds was performed, a polarizer and a polarizing plate were manufactured by processes the same as those of Comparative Example 1.

### Inventive Example 6

With the exception that zinc chloride of 3 wt. % was added in the dyeing process (A), the concentrations of potassium iodide and boron were adjusted to 7.0 wt. % and 0.46 wt. % respectively, in the cross-linking and stretching processes (B), and the polyvinyl alcohol film was immersed in distilled water of 25° C. (degrees Celsius) for 20 seconds during the washing process (C), a polarizer and a polarizing plate were manufactured by processes the same as those of Comparative Example 1.

### Inventive Example 7

With the exception that zinc sulfate of 5 wt. % was added in the cross-linking and stretching processes (B) and then the washing process (C) of immersing the polyvinyl alcohol film in distilled water of 25° C. (degrees Celsius) for 10 seconds was performed, a polarizer and a polarizing plate were manufactured by processes the same as those of Comparative Example 1.

### Inventive Example 8

With the exception that zinc sulfate of 5 wt. % was added in the cross-linking and stretching processes (B) and then the washing process (C) of immersing the polyvinyl alcohol film in distilled water of 25° C. (degrees Celsius) for 30 seconds was performed, a polarizer and a polarizing plate were manufactured by processes the same as those of Comparative Example 1.

### Inventive Example 9

With the exception that zinc chloride of 3 wt. % was added in the dyeing process (A), an ammonium phosphate monobasic of 0.5 wt. % was added in the cross-linking and stretching processes (B), and then the washing process (C) of immersing the polyvinyl alcohol film in distilled water of 25° C. (degrees Celsius) for 20 seconds was performed, a polarizer and a polarizing plate were manufactured by processes the same as those of Comparative Example 1.

### Inventive Example 10

With the exception that zinc chloride of 3 wt. % was added in the dyeing process (A), an ammonium phosphate monobasic of 1.5 wt. % was added in the cross-linking and stretching processes (B), and then the washing process (C) of immersing the polyvinyl alcohol film in distilled water of 25° C. (degrees Celsius) for 20 seconds was performed, a polarizer and a polarizing plate were manufactured by processes the same as those of Comparative Example 1.

The following table 2 shows that kinds of phosphorus compound, and contents of zinc salt, phosphorus compound, I₂, KI and boron in the processing solutions in the dyeing process (A) and the cross-linking and stretching processes (B), and immersion times in the washing process (C), according to Comparative Examples 1 to 7 and Inventive Examples 1 to 10.

### Experimental Example

### Heat Resistance Evaluation

The polarizing plates manufactured through the processes according to Comparative Examples 1 to 7 and Inventive Examples 1 to 10 were cut to have a size of 50 mm (millimeters)×50 mm (millimeters), and the cut polarizing plates were bonded to glass using acrylic adhesives, such that samples were prepared. Thereafter, initial optical properties of each polarizing plate, i.e., single transmittance (Ts), cross transmittance (Tc), single color (a, b), and cross color (x, y) were measured. Subsequently, the polarizing plates were left standing in an oven at 100° C. (degrees Celsius) for 500 hours, and then the foregoing optical properties were re-measured. The optical properties of the polarizing plates before/after heating were compared, and each of ΔL*ab relative variations, cross color x relative variations, and Tc relative variations according to B*Zn/K values are shown in table 3.

The optical properties of polarizing plates manufactured through the processes according to Comparative Examples 1 to 7 and Inventive Examples 1 to 10 were measured by an N&K analyzer (N&K Technology Inc.) Single optical properties L*, a*, and b* were measured through one polarizing plate. One polarizing plate was cut in a stretched direction and the other polarizing plate was cut in a cross direction with respect to the stretched direction. Then, the two cut polarizing plates were positioned orthogonally in such a manner that the absorption axes thereof were at 90° with respect to each other, and then cross transmittance (Tc) and cross color (x, y) were measured therefrom.

Heat resistance variance was calculated as follows.

ΔL*ab=[(L*₅₀₀−L*₀)²+(a*₅₀₀−a*₀)²+(b*₅₀₀−b*₀)²]^{0.5}

(Where L*, a*, and b* are color values in a single state and are L*, a*, and b* color values of a Color Space color coordinate system (defined by the CIE in 1976), respectively. These values were measured with one polarizing plate sample by using the N & K analyzer. L*₀, a*₀, and b*₀ are color values of the polarizing plate in an initial single state, and L*₅₀₀, a*₅₀₀, and b*₅₀₀ are color values in a single state measured after being left standing in an oven at 100° C. for 500 hours.)

Tc(%)=100×(Tc₅₀₀−Tc₀)/Tc₀

(Where Tc₀ is an initial cross transmittance of each polarizing plate, Tc₅₀₀ is a cross transmittance measured after each polarizing plate was left standing in an oven at 100° C. for 500 hours, and the cross transmittance (Tc) was measured at the same single transmittance value (Ts).)

x(%)=100×(x₅₀₀−x₀)/x₀

(Where x is a color value of two polarizing plates in a cross state. x denotes a color value of xyz Chromaticity coordinates and is calculated from cross color values of two polarizing plates using the N & K analyzer. x₀ is a color value of the polarizing plate in an initial cross state, and x₅₀₀ is a color value of the polarizing plate in an cross state measured after having been left standing in an oven at 100° C. for 500 hours.)

Relative variation of ΔL*ab=ΔL*ab of Example/ΔL*ab of Comparative Example 1

Relative variation of Tc=Tc (%) of Example/Tc (%) of Comparative Example 1

Relative variation of x=x (%) of Example/x (%) of Comparative Example 1

Inorganic Content Analysis

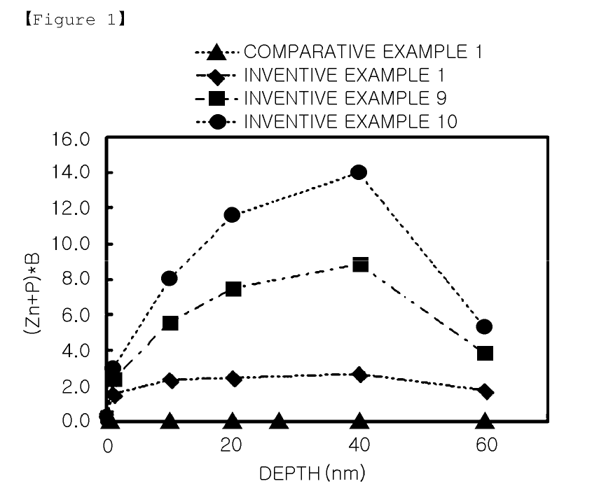

Residual inorganic contents (zinc, boron, potassium contents) within the polarizers according to Comparative Examples 1 to 7 and Inventive Examples 1 to 10 were analyzed by Inductively Coupled Plasma-Atomic Emission Spectroscopy (ICP-AES method), and Zn*B/K values in the polarizers were calculated from the analyzed inorganic contents and shown in the following table 2. Concretely, a sample (polarizer) of 0.1 g (gram), to be measured, was positioned in a vessel, and the sample was dissolved by adding 2 ml (milliliters) of distilled water and 3 ml (milliliters) of concentrated nitric acid thereto and closing the lid of the vessel. Thereafter, when the sample was completely dissolved, the solution having the sample dissolved therein was diluted with 50 ml (milliliters) of ultrapure water added thereto. Thereafter, the diluted solution was decuple-diluted again, and then analyzed by Inductively Coupled Plasma-Atomic Emission Spectrometer (ICP-AES). An ICP-AES (ICP 5300DV, Perkinelemer) was operated under the following conditions: Forward Power 1300 W; Torch Height 15 mm (millimeters); plasma gas flow 15.00 L (liters)/min; sample gas flow 0.8 L (liters)/min; auxiliary gas flow 0.20 L/min and pump speed 1.5 ml (millimeters)/min.

[Zn+P]*B value of residual inorganic contents within the polarizers according to Comparative Example 1 and Inventive Examples 1, 9 and 10 were analyzed by Electron Spectroscopy of Chemical Analysis (ESCA) and shown in FIG. 1. In the ESCA method, the surface of the polarizer was etched step by step as in Table 1 and then, by using photoelectron spectroscopy (XPS or ESCA, model name ESCALAB 250(VG)), atomic percentages (at %) of respective zinc, phosphorus and boron were measured from respective locations of the polarizer. From the measured atomic percentages (at %) of respective zinc, phosphorus and boron contents, the weights of respective elements were calculated, such that the values of [Zn+P]*B were calculated. Meanwhile, ESCA analysis conditions are as follows.

<ESCA Analysis Condition>

(1) Total ESCA System Conditions

Base chamber pressure: 2.5×10⁻¹⁰ mbar

X-ray source: monochromatic Al Kα (1486.6 eV)

X-ray spot size: 400 μm (micrometers)

Lens mode: Large Area XL

Operation mode: Constant Analyzer Energy (CAE) mode

Ar ion etching: etching rate ˜0.1 nm/sec (Mag 10) SiO₂ basis

Charge compensation: low energy electron flood gun used, ion flood gun not used.

(2) Etching of the Polarizer

Contents of zinc, phosphorus, and boron to a depth of 200 nm from the surface of the polarizer were measured by etching the polarizer for the etching time of the following Table 1. Through etching for 10 seconds, 1 nm (nanometer) of the polarizer was etched. In the present experiment, the contents of zinc, phosphorus and boron in respective location of the polarizer were measured by etching to a depth of total 200 nm (2000 seconds) step by step denoted as the following Table 1.

TABLE 1

| | Etching time | Total etching time |
|---|---|---|
| Step | (seconds) | (seconds) |
| 1 | 0 | 0 |
| 2 | 10 | 10 |
| 3 | 90 | 100 |
| 4 | 100 | 200 |
| 5 | 200 | 400 |
| 6 | 200 | 600 |
| 7 | 200 | 800 |
| 8 | 200 | 1000 |
| 9 | 200 | 1200 |
| 10 | 200 | 1400 |
| 11 | 200 | 1600 |
| 12 | 200 | 1800 |
| 13 | 200 | 2000 |

TABLE 2

| | | | | B. Cross-linking and | | | | | | | |
|---|---|---|---|---|---|---|---|---|---|---|---|
| | A. Dyeing Process | | | stretching Processes | | | | Contents in polarizer | | | |
| | | | Zinc | | | Zinc | | Zn * | | | |
| | I₂ | KI | salt | KI | B | salt | Washing | B/K | B | K | Zn |
| | (wt %) | (wt %) | (wt %) | (wt %) | (wt %) | (wt %) | Time(s) | Value | (wt %) | (wt %) | (wt %) |
| Comparative | 0.1 | 1 | 0 | 5.0 | 0.64 | 0 | — | 0 | 2.10 | 1.10 | 0 |
| Example 1 | | | | | | | | | | | |
| Comparative | 0.1 | 1 | 0 | 5.0 | 0.22 | 2.5 | — | 0.0087 | 0.24 | 1.60 | 0.58 |
| Example 2 | | | | | | | | | | | |
| Comparative | 0.1 | 1 | 0 | 1.5 | 0.64 | 2.5 | — | 4.39 | 2.30 | 0.22 | 0.42 |
| Example 3 | | | | | | | | | | | |
| Comparative | 0.1 | 1 | 0 | 5.0 | 0.64 | 2.5 | 100 | 0.086 | 1.3 | 0.3 | 0.02 |
| Example 4 | | | | | | | | | | | |
| Comparative | 0.03 | 7 | 0 | 10 | 0.92 | 0.16 | 60 | 0.078 | 1.6 | 2.45 | 0.12 |
| Example 5 | | | | | | | | | | | |
| Comparative | 0.1 | 1 | 0 | 0.01 | 0.64 | 1.0 | — | 6.6 | 2.2 | 0.15 | 0.45 |
| Example 6 | | | | | | | | | | | |
| Comparative | 0.3 | 1 | 0 | 5 | 2.5 | 2.5 | 20 | 5.23 | 8.1 | 0.65 | 0.42 |
| Example 7 | | | | | | | | | | | |
| Inventive | 0.1 | 1 | 0 | 5 | 0.64 | 2.5 | 20 | 1.38 | 2.20 | 0.7 | 0.44 |
| Example 1 | | | | | | | | | | | |
| Inventive | 0.1 | 1 | 0 | 5 | 0.64 | 5.0 | 20 | 2.08 | 2.40 | 0.67 | 0.58 |
| Example 2 | | | | | | | | | | | |
| Inventive | 0.1 | 1 | 0 | 7 | 0.64 | 5.0 | 20 | 1.56 | 2.40 | 0.97 | 0.63 |
| Example 3 | | | | | | | | | | | |
| Inventive | 0.1 | 1 | 0 | 5 | 0.46 | 2.5 | 20 | 0.85 | 1.40 | 1.00 | 0.61 |
| Example 4 | | | | | | | | | | | |
| Inventive | 0.1 | 1 | 0 | 7 | 0.46 | 2.5 | 20 | 0.58 | 1.30 | 1.60 | 0.71 |
| Example 5 | | | | | | | | | | | |
| Inventive | 0.1 | 1 | 3 | 7 | 0.46 | 0 | 20 | 0.10 | 1.33 | 1.72 | 0.13 |
| Example 6 | | | | | | | | | | | |
| Inventive | 0.1 | 1 | 0 | 5 | 0.64 | 5.0 | 10 | 4.0 | 2.60 | 0.58 | 0.90 |
| Example 7 | | | | | | | | | | | |
| Inventive | 0.1 | 1 | 0 | 5 | 0.64 | 5.0 | 30 | 1.33 | 2.0 | 0.6 | 0.4 |
| Example 8 | | | | | | | | | | | |
| Inventive | 0.1 | 1 | 3 | 5 | 0.64 | ammonium | 20 | 0.42 | 1.88 | 1.11 | 0.25 |
| Example | | | | | | phosphate | | | | | |
| 9⁽¹⁾ | | | | | | monobasic | | | | | |
| | | | | | | 0.5 | | | | | |
| Inventive | 0.1 | 1 | 3 | 5 | 0.64 | ammonium | 20 | 0.29 | 2.01 | 1.30 | 0.19 |
| Example | | | | | | phosphate | | | | | |
| 10⁽¹⁾ | | | | | | monobasic | | | | | |
| | | | | | | 1.5 | | | | | |

⁽¹⁾A phosphorus compound was added in Inventive Examples 9 and 10

TABLE 3

| | | Variance before and after Heat Resistance | | | |
|---|---|---|---|---|---|
| | Inorganic | Δ L*ab | Tc | X | Initial orthogonal |
| | content | relative | relative | relative | properties |
| | B*Zn/K | variations | variations | variations | Tc/Tc_{Comparative example 1} |
| Comparative | 0.00 | 1.00 | 1.00 | 1.00 | 1.00 |
| Example 1 | | | | | |
| Comparative | 0.087 | 1.14 | 1.07 | 1.05 | 2.00 |
| Example 2 | | | | | |
| Comparative | 4.39 | 1.21 | 1.20 | 1.50 | 1.70 |
| Example 3 | | | | | |
| Comparative | 0.086 | 1.15 | 1.12 | 1.20 | 1.60 |
| Example 4 | | | | | |
| Comparative | 0.078 | 1.3 | 1.4 | 1.56 | 1.32 |
| Example 5 | | | | | |
| Comparative | 6.6 | 1.5 | 1.32 | 1.2 | 2 |
| Example 6 | | | | | |
| Comparative | 5.23 | 1.32 | 1.22 | 1.45 | 1.86 |
| Example 7 | | | | | |
| Inventive | 1.38 | 0.80 | 0.22 | 0.44 | 1.01 |
| Example 1 | | | | | |
| Inventive | 2.08 | 0.66 | 0.11 | 0.20 | 0.95 |
| Example 2 | | | | | |
| Inventive | 1.56 | 0.80 | 0.18 | 0.43 | 0.98 |
| Example 3 | | | | | |
| Inventive | 0.85 | 0.84 | 0.37 | 0.47 | 1.13 |
| Example 4 | | | | | |
| Inventive | 0.58 | 0.88 | 0.51 | 0.59 | 0.95 |
| Example 5 | | | | | |
| Inventive | 0.10 | 0.93 | 0.71 | 0.72 | 1.11 |
| Example 6 | | | | | |
| Inventive | 4.0 | 0.85 | 0.50 | 0.30 | 0.98 |
| Example 7 | | | | | |
| Inventive | 1.33 | 0.75 | 0.25 | 0.3 | 1.0 |
| Example 8 | | | | | |
| Inventive | — | 0.52 | 0.10 | 0.17 | 1.1 |
| Example 9 | | | | | |
| Inventive | — | 0.41 | 0.05 | 0.08 | 1.2 |
| Example 10 | | | | | |

*Tc/Tc_{Comparative example 1} is a value calculated by measuring a ratio of the initial cross transmission of each polarizing plate manufactured by the processes according to Comparative Examples 2 to 7 and Inventive Examples 1 to 10, based on the fact that the initial cross transmission of the polarizing plate manufactured by the processes according to Comparative Example 1 refers to Tc_{Comparative example 1} = 1.0. Here, Tc refers to a cross transmission of each polarizing plate. Tc_{Comparative example 1} refers to a cross transmission of Comparative of Example 1. The cross transmission (Tc) of each of the Comparative Examples and Inventive Examples is measured from the same single transmittance (Ts). The fact that the cross transmission measured from the same single transmittance (Ts) is lower means that the orientation of constituents absorbing light is improved.
*Tc relative variance refers to Tc variance before and after heating.

As shown in the Tables 2 and 3, and FIG. 1, the polarizing plate including the polarizer having the value of Zn*B/K, the value of [Zn+P]*B, the boron content, the potassium content satisfying the foregoing ranges according to an embodiment of the present invention may have excellent initial optical properties and have a relatively small variance in color and cross transmittance after heating, as compared to the Comparative Examples. In this manner, the polarizer and the polarizing plate according to an embodiment of the present invention may have excellent durability and heat resistance and small variances in optical properties under conditions of high temperature and humidity, by which the polarizer and the polarizing plate may obtain superior properties even under harsh conditions.

1. A polarizer having a value of zinc content (percent by weight, wt. %)×boron content (wt. %)/potassium content (wt. %) in a range of 0.1 to 4.0, boron content in a range of 1.0 to 5.0 wt. % and potassium content in a range of 0.3 to 2.0 wt. %, based on a weight of the polarizer.

2. The polarizer of claim 1, wherein the polarizer has a value of [zinc content (wt. %)+phosphorus content (wt. %)]×boron content (wt. %) in a range of 0.2 to 14.0 in respective locations, at which a depth (D) ranging from a surface of the polarizer to a center thereof satisfies 1 nm (nanometer)≦D≦60 nm (nanometers).

3. The polarizer of claim 1, wherein zinc is derived from at least one selected from a group consisting of zinc chloride, zinc iodide, zinc sulfate, zinc nitrate, and zinc acetate.

4. The polarizer of claim 1, wherein boron is derived from at least one selected from a group consisting of boric acid, borate, and borax.

5. The polarizer of claim 2, wherein phosphorus is derived from at least one selected from a group consisting of phosphoric acid, a calcium phosphate dibasic, a magnesium phosphate dibasic, a sodium phosphate dibasic, an calcium phosphate monobasic, and an ammonium phosphate monobasic.

6. A polarizing plate comprising the polarizer of claim 1.

7. An image display device comprising the polarizer of claim 1.

8. A method of manufacturing a polarizer comprising at least a dyeing process, a cross-linking process, a stretching process, and a washing process;
the dyeing process being performed by immersing a polyvinyl alcohol based film in an aqueous dyeing solution having an iodine concentration in a range of 0.05 wt. % to 0.2 wt. % (percent by weight), a potassium iodide concentration in a range of 0.2 wt. % to 1.5 wt. %, and a temperature in a range of 20° C. to 40° C. (degrees Celsius) for 150 seconds to 300 seconds;
the cross-linking process being performed by immersing the polyvinyl alcohol based film in an aqueous cross-linking solution having a boron concentration in a range of 0.36 wt. % to 0.83 wt. %, a potassium iodide concentration in a range of 4 wt. % to 7 wt. %, and a temperature in a range of 15° C. to 60° C. (degrees Celsius) for 30 seconds to 120 seconds;
at least one kind of zinc salt selected from a group consisting of zinc chloride, zinc iodide, zinc sulfate, zinc nitrate, and zinc acetate being included in at least one of the aqueous dyeing solution, the aqueous cross-linking solution, and a separate aqueous zinc salt processing solution in a concentration of 0.4 wt. % to 7.0 wt. %; and
the washing process being performed by immersing the PVA based film in pure water having a temperature of 25° C. to 30° C. (degrees Celsius) for 10 seconds to 30 seconds.

9. The polarizer of claim 8, wherein boron is derived from at least one selected from a group consisting of boric acid, borate, and borax.

10. The polarizer of claim 8, wherein at least one of the aqueous dyeing solution, the aqueous cross-linking solution, and a separate aqueous phosphorus compound solution contains at least one phosphorus compound selected from a group consisting of phosphoric acid, a calcium phosphate dibasic, a magnesium phosphate dibasic, a sodium phosphate dibasic, a calcium phosphate monobasic, and an ammonium phosphate monobasic, in a concentration of 10 wt. % or less.

11. A polarizing plate comprising the polarizer of claim 2.

12. A polarizing plate comprising the polarizer of claim 3.

13. A polarizing plate comprising the polarizer of claim 4.

14. A polarizing plate comprising the polarizer of claim 5.

15. An image display device comprising the polarizer of claim 2.

16. An image display device comprising the polarizer of claim 3.

17. An image display device comprising the polarizer of claim 4.

18. An image display device comprising the polarizer of claim 5.
